(19) United States
(12) Patent Application Publication
(10) Pub. No.: US 2011/0168488 A1
(43) Pub. Date: Jul. 14, 2011

(54) Kit and method for emergency descent from a height

(75) Inventors: Marco Simard, Brossard (CA); Daniel Landry, Terrebonne (CA)

(73) Assignees: Nouvelle Hauteur Inc.; Self Rescue Inc.

(21) Appl. No.: 12/930,689

(22) Filed: Jan. 11, 2011

(30) Foreign Application Priority Data
Jan. 12, 2010 (CA) 2689905

(51) Int. Cl. A62B 35/04

(52) U.S. Cl. 182/5

(57) ABSTRACT

A method and kit for emergency descent from a high structure by a user is described herein. The kit includes a rope-friction controller including a first attaching element for attaching the rope-friction controller to the wearable safety equipment of the user, a rope cooperatively engaged in the rope-friction controller, a second attaching element coupled to the rope for securing the rope to the structure via a link, and a pulley fixed to one of the rope, near the second attaching element, and the second attaching element, for creating a hoist with the rope and the first attaching element. The hoist allows removing at least some of the weight of the user from the link so as to allow the user to detach himself from the link and to use the rope-friction controller in cooperation with the rope to descent the high structure.

### FIELD

The present invention relates to safety, emergency evacuation and/or rescue equipments. More specifically, the present invention is concerned with a kit for emergency descent from a height and to a method therefor.

### BACKGROUND

It is conventionally accepted and regulated by governing bodies that a worker that has to climb in the course of its work or that otherwise works above a specific height must wear a safety harness that is so secured as to prevent the worker from accidentally falling to the ground.

Such a safety harness, which can also be used as an emergency evacuation device, is usually attached to a structure with a lanyard that is long enough to give to the worker enough freedom to carry on the work but short enough to prevent his fall to the ground or to hit any obstacle should the worker falls from the structure. Following a fall, the lanyard allows the worker to remain suspended from the structure, waiting to be rescued.

A problem with such a set-up may occur when the worker is alone or in any situations where help may take time to arrive. Indeed, being suspended by a harness may cause problems if it lasts too long, such as a blood circulation problem called orthostatic intolerance or suspension trauma.

Many methods and devices are known in the art to allow a control descent from a height. Such methods and devices allow applying a control friction on a rope used to descent, thereby controlling the speed of the descent.

Some of these devices, often referred to as descenders, include automatic braking of the rope when they are not operated by the user, and a panic mode when operated or push beyond the descent control position.

However, none of the known emergency descent control method and device from the prior art is at the same time simple in its operation, small to be carried at all time by the user, reliable and heavy-duty.

### SUMMARY OF THE INVENTION

More specifically, in accordance with embodiments of the present invention, there is provided a kit for emergency descent from a high structure by a user characterized by having a weight, wearing a wearable safety equipment and being attached to the high structure via at least one link attached to the user via the wearable safety equipment; the kit comprising:

a rope-friction controller including a first attaching element for attaching the rope-friction controller to the wearable safety equipment;

a rope cooperatively engaged in the rope-friction controller;

a second attaching element coupled to the rope for securing the rope to the structure via the link;

a pulley coupled to one of the rope, near the second attaching element, and the second attaching element, for creating a hoist with the rope and the first attaching element; the hoist allowing to remove at least some of the weight of the user from the link so as to allow the user detaching himself from the link and to use the rope-friction controller in cooperation with the rope to descent the high structure.

According to other embodiments of the present invention there is provided a method for emergency descent from a high structure by a user characterized by having a weight, wearing a wearable safety equipment and being attached to the high structure via at least one link attached to the user via the wearable safety equipment, the method comprising:

attaching a rope-friction controller having a rope engaged therein to the wearable safety equipment;

attaching the rope to the at least one link;

coupling a pulley to a portion of the rope near the at least one link;

creating a loop with the rope;

creating a hoist with the loop and the pulley;

using the hoist to remove at least some of the weight of the user from the at least one link;

detaching the wearable safety equipment from the at least one link; and

using the rope-friction controller in cooperation with the rope to descent the high structure.

It is to be noted that the expression structure should not be limited to man-made constructions and should be construed broadly so as to include any man-made constructions and any natural elements such as trees and rocks.

Other objects, advantages and features of the present invention will become more apparent upon reading the following non restrictive description of illustrated embodiments thereof, given by way of example only with reference to the accompanying drawings.

### BRIEF DESCRIPTION OF THE DRAWINGS

In the appended drawings:

FIGS. 1 to 7 illustrate the steps for operating a kit for emergency descent in an emergency situation according to an embodiment of the invention; and

FIGS. 8A and 8B are a cross-sections of a second embodiment of an emergency descent control device; FIG. 8A illustrating the device in a non-friction position, and FIG. 8B illustrating the device in a panic mode of operation.

While the invention will be described in conjunction with illustrated embodiments, it will be understood that it is not intended to limit the scope of the invention to such embodiments.

### DETAILED DESCRIPTION

In the following description, similar features in the drawings have been given similar reference numerals, and in order not to weigh down the figures, some elements are not referred to in some figures if they were already identified in a precedent figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

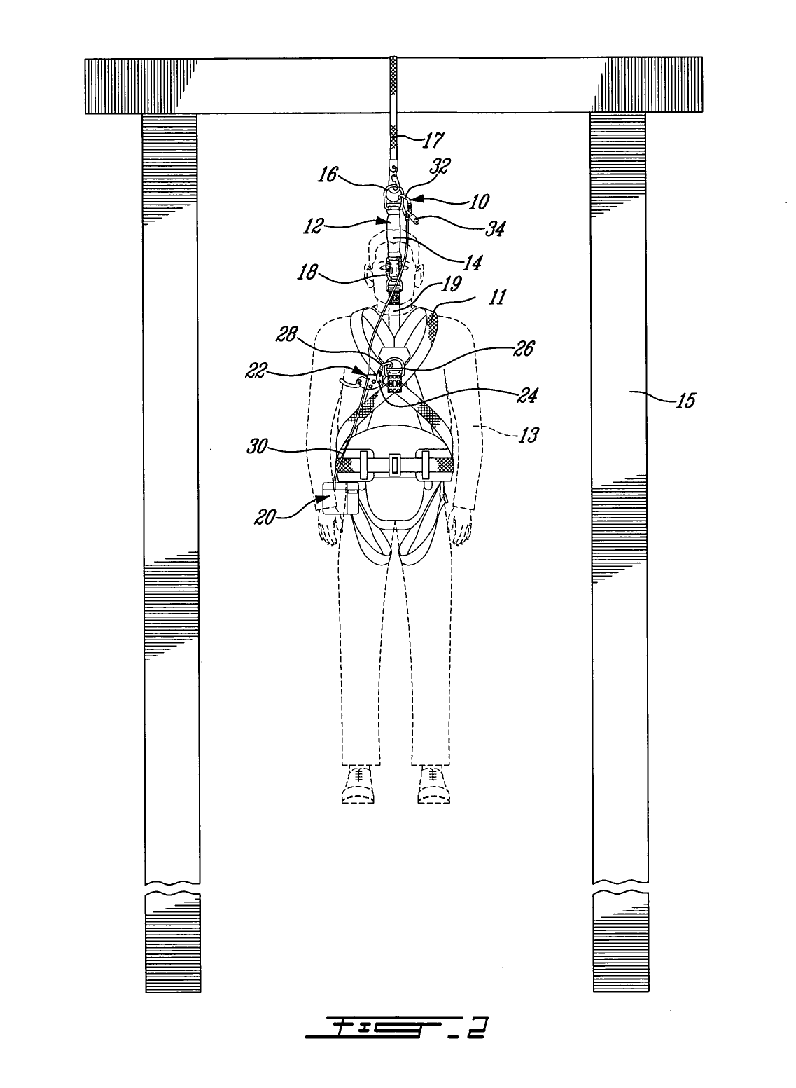

Turning first to FIG. 2 of the appended drawings, a rescue kit 10 for an emergency descent from a height according to an embodiment of the present invention will be described.

The rescue kit 10 is to be used with wearable safety equipment, such as a safety harness 11, worn by a person 13 during the course of its work or of any other activity occurring on a high structure 15.

The rescue kit 10 includes a lanyard 12 for attaching the person 13 to the structure 15. More specifically, the lanyard 12 is attached to both the harness 11 and to a cable 17, to any fall protection connecting element (not shown) or to any other element part or mounted to the structure 15.

According to a further embodiment (not shown), the lanyard 12 is omitted and the harness 11 is directly secured to the cable 17.

Generally stated, any secure link element or combination of attachment or link elements can be provided between the harness 11 and the structure 15 for securing the person 13 to the structure 15 should a fall thereof occurs.

The lanyard 12 comprises a strap 14 having a first attachment, in the form of a D-Ring 16 for attaching a first end of the strap 14 to the structure 15 via the cable 17 and a second attachment, in the form of a carbineer 18, for attaching the second end of the strap 14 to the harness 11.

The strap 14 is made of nylon, polyester, a combination thereof or of any other equivalent load bearing material known in the art.

It is to be noted that elements present in the composition of the lanyard 12 advantageously meets or exceeds CSA or ANSI standards.

It is also to be noted that the carbineer 18 and D-rings 16 can be replaced by other attachment means that also meet or exceed CSA or ANSI standards.

The lanyard 12 is attached to the dorsal D-Ring of a CSA Z259.10 or ANSI Z359.1 harness 11 as an adapter or connector. Advantageously, the lanyard 12 is to stay attached to the harness 11 at all time when the person 13 is to be positioned on the structure 15 and can be seen as being a length extension of the dorsal strap 19 of the harness.

According to another embodiment (not shown), the lanyard 12 is further configured so as to allow absorbing the shock resulting from the person 13 falling from the structure 15.

Since the use of the lanyard 12 is believed to be well-known in the art, it will not be described further in more detail.

The kit 10 further comprises an emergency descent package 20. The emergency descent control package 20 is in the form of a small package having therein an emergency descent control device 22, including a rope-friction controller 24 to be mounted to a frontal D-ring 26 of the harness 11 via a first carabineer 28, a rope 30 passing through the rope-friction controller 24 and provided with a second carabineer 32 and a small pulley 34 attached to the carabineer 32.

The device manufactured by Sécurité Landry under model number DSSR07 has been found adequate to be used as the emergency descent control device 22. Such an emergency descent control device 22 includes a 4, 4.5 or 5 mm Vectran™ rope 30. Any other rope with sufficient tensile strength, for example sufficient to withstand the weight of an average weight male adult, can also be used. Examples of such ropes include, without limitations, Technora™ and Dynema™ ropes. The package 20 is configured so as to be attached to a belt or include conventional attachment means allowing the person 13 to wear it during the course of its work on the high structure 15. Also, the package 20 is dimensioned so as to receive the device 22 and a length of rope 30 sufficient so as to allow the person descending the structure 15.

According to a further embodiment (not shown), the device 22 is configured so as to allow a panic mode of operation, as illustrated in Canadian Patent Application No. 2,639,425 filed on Sep. 8, 2008, naming Marco Simard et Daniel Landry as the inventors and titled “Rescue Lanyard and Kit for Emergency Descent from a Height Including an Emergency Descent Control Device” and which is incorporated herewith by reference.

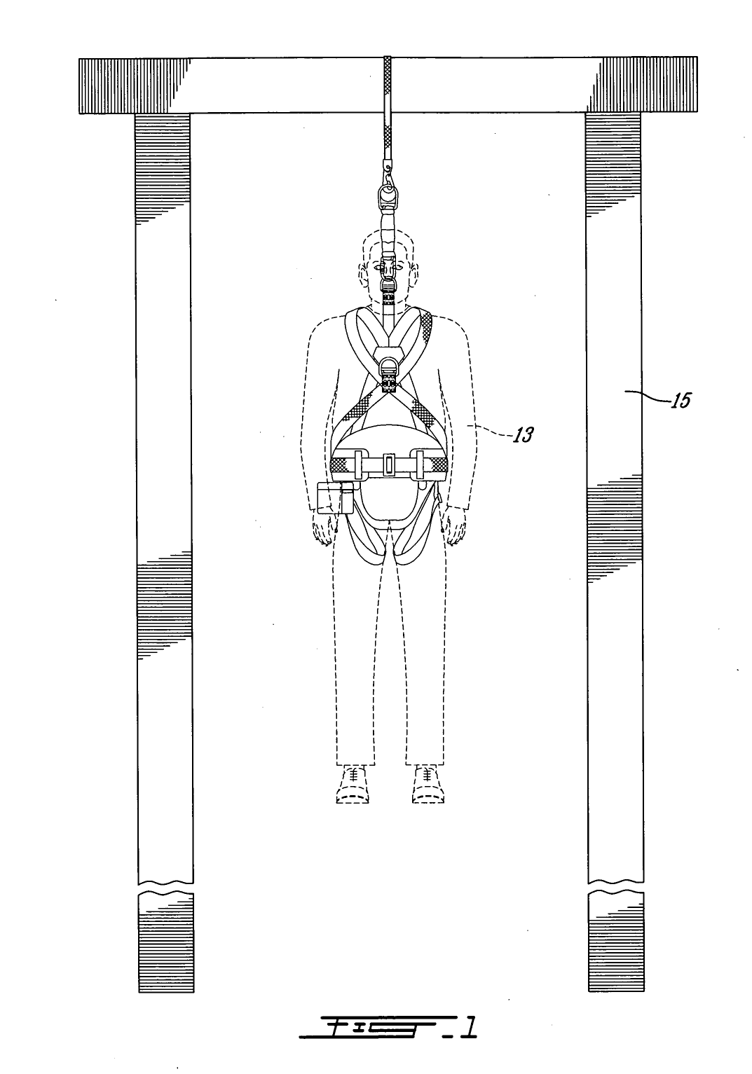

FIGS. 1 to 7 illustrate an example of the various steps to be performed by the user 13 to reach safety.

The user 13 is shown in a simulated rescue requiring position in FIGS. 1 to 7. More specifically, the user 13 cannot reach any point of contact to help him reach the ground safely.

More specifically, FIG. 1 illustrates the user 13 of the kit 10 attached to the cable 17 by the lanyard 12 and hanging from the structure 15.

FIG. 2 illustrates the first step of a method for emergency descent according to an embodiment of the present invention.

According to this first step, the user 13 opens the package 20 so as to access the carabineer 32 at the first end of the rope 30 and the device 22 and then attached the device 22 to the frontal D-ring 26 of the harness 11 via the carabineer 28 and the second carabineer 32 to the D-ring 16 of the lanyard 12 which is attached to the cable 17.

It is to be noted that the rope 30 has been conveniently pre-inserted in the device 22 so that the device 22 is ready for use.

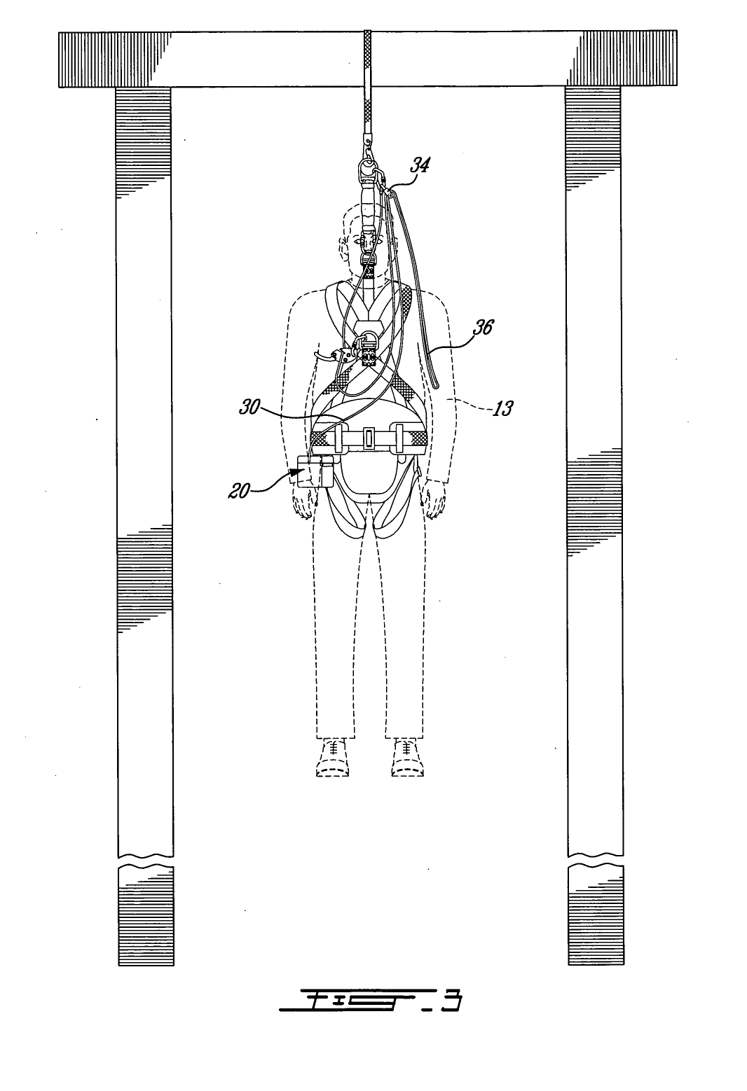

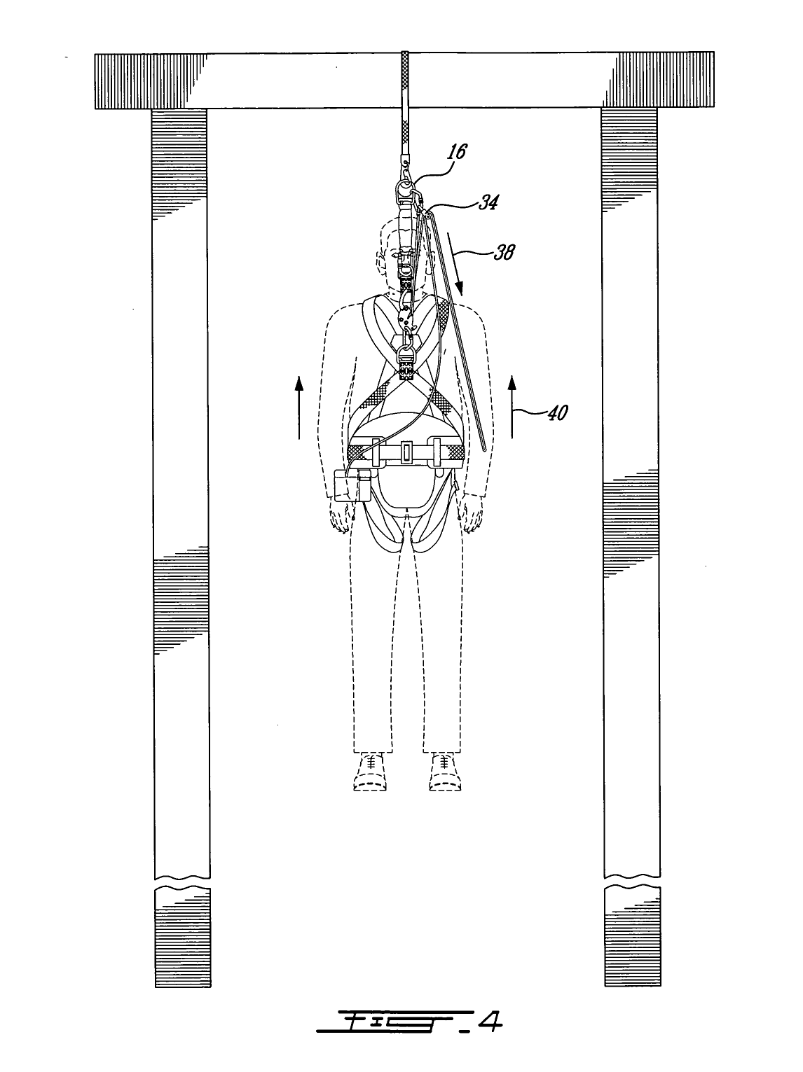

In the next step, which is illustrated in FIG. 3, the user 13 creates a loop 36 with a portion of the rope 30 picked between the package 20 and the device 22 and insert the loop 36 in the pulley 34 so as to create a hoist so that, as illustrated in FIG. 4, pulling on the loop 36 (see arrow 38) causes the user 13 to raise relative to the lanyard 12 (see arrow 40).

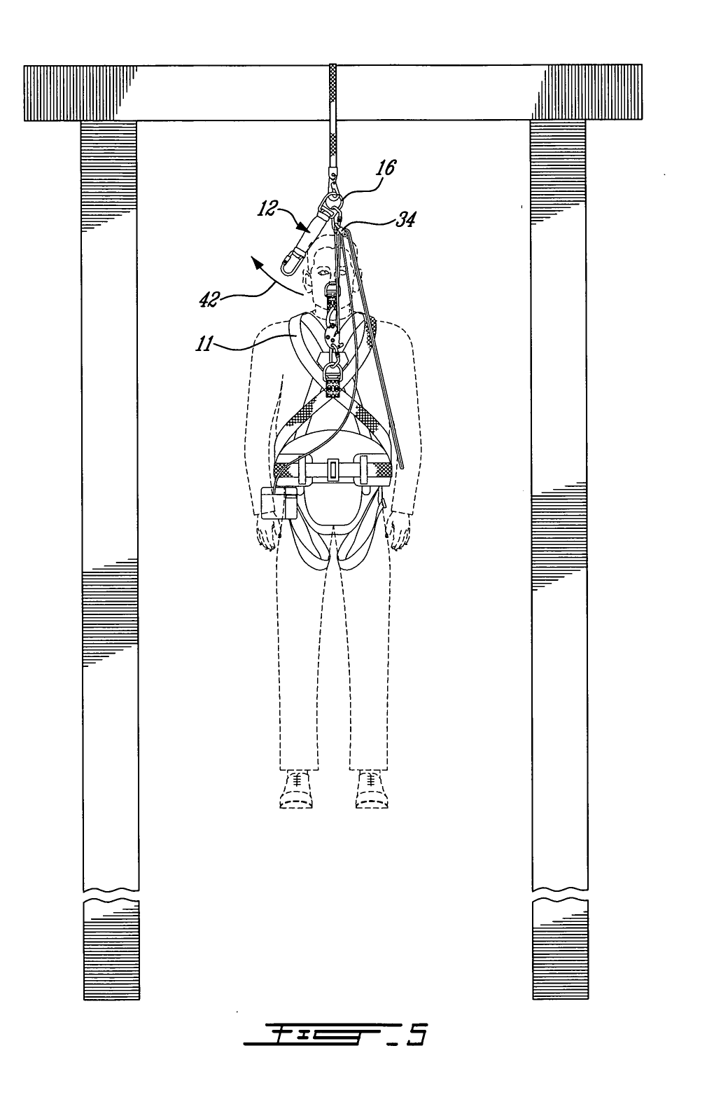

Creating a hoist suspended to the higher D-ring 16 of the lanyard 12 allows removing the weight of the user 13 onto the lanyard 12 which can then be detached from the harness 11 by the user 13, as illustrated in FIG. 5 (see arrow 42).

In the case wherein no lanyard 12 is used, the created hoist similarly allows removing weight onto the cable 17, which can then be detached from the harness 11 by the user 13.

Using the pulley 34 and the rope 30 for its raising serves two purposes to the user 13: 1) it allows removing its weight from the lanyard 12, and 2) it better positions the user 13 for detaching the lanyard 12 from the harness 11.

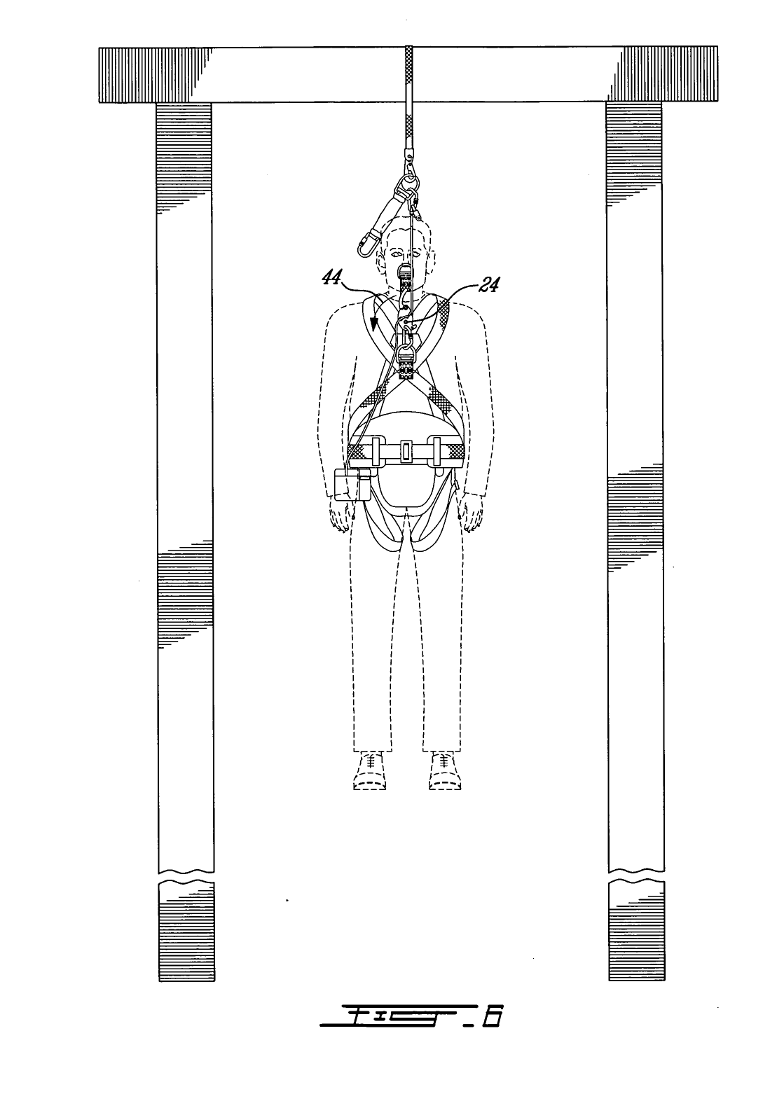

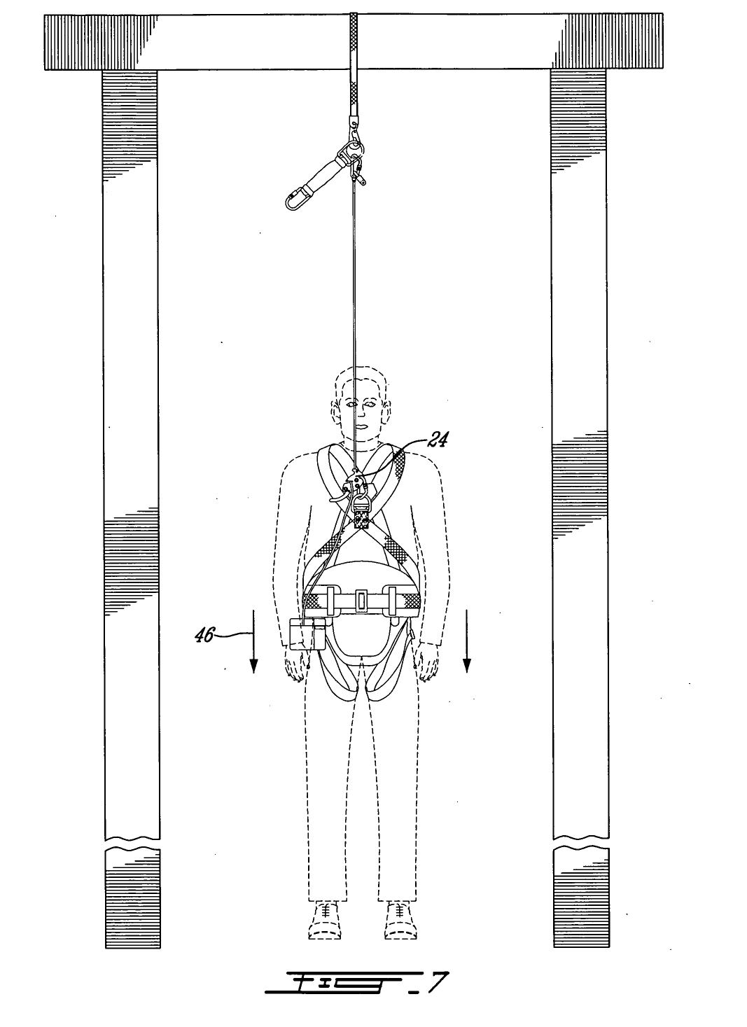

As illustrated in FIGS. 6 and 7, the user 13 may then pull back the rope 30 out of the pulley 34 and use the descent device 22 (see arrow 44) to descent to the ground (see arrow 46) in a controlled manner until the ground is reached as shown in FIG. 7.

It is to be noted that the pulley 34 may take any form allowing receiving the loop 36 and creating a hoist with therewith. According to the illustrated embodiment, the pulley 34 includes a roller mounted in a U-shaped bracket. According to another embodiment (not shown), the pulley may be in the form of a ring having a friction-less coating portion or sleeve.

The operation of the device 22 is described in detail in the above-mentioned Canadian Patent Application no. 2,639,425.

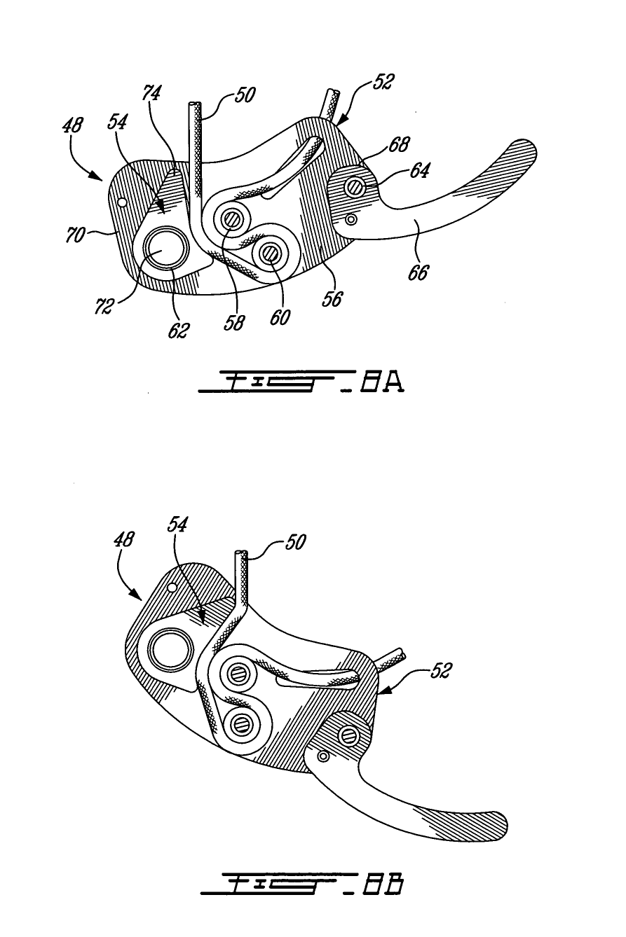

FIG. 8 shows a cross-section of an emergency descent control device 48 according to a second embodiment. Since the construction and operation of this particular device 48 are similar to those of the device described in the '425 Canadian Patent Application referred to hereinabove, and for concision purposes, only the differences between the two devices will be described herein.

Similarly to the device 22, more or less friction can be applied on the rope 50 passing through the device 48 depending on the orientation of the device 48 relative to the generally vertical tensed portion of the rope 50 between the device 48 and the attachment 16 when the user 13 descents to the ground.

The device 48 includes a rope friction controller 52, the rope 50 passing therethrough, and a safety element, in the form of a friction finger 54.

The friction controller 52 includes two identical slightly arcuate rectangular plates 56 (only one shown) distanced and assembled by bushing elements 58-60 further acting as pivot points and friction members for the rope 50 as will be described furtherin in more detail, by the mounting bushing 62 of the friction finger 54 and by the pivot pin 64 of the handle 66.

The gap between the two plates 56 defines a rope-receiving portion for receiving a portion of the rope 50 therein and for selectively applying friction thereon. The distance between the first and second plates 56 is adapted for the calibre of the rope 50. More specifically, the rope 50 is snugly received in the rope-receiving portion of the friction controller 52. The friction controller 52 is generally oblong and defines first and second longitudinal ends 68 and 70.

The two plates 56 are made of a heavy-duty material such as, without limitations, a metal, a high-density polymer or a composite material.

The rope friction controller 52 further includes an attachment portion, in the form of registered holes 72 in the plates 56 adjacent the second longitudinal end 86, for securing the emergency descent control device 48 to the harness 11 of the user 13 and defining a pivot axis for the device 48.

The aforementioned handle 66 is distanced from the attachment portion 72 to allow pivoting the rope friction controller 52 about the pivot axis 72 from a neutral position wherein friction is so applied on the rope 50 as to prevent movement thereof in the rope-receiving portion, to a descent or non-friction position wherein minimal friction is applied on the rope 50 so as to allow movement thereof in the rope-receiving portion 52.

The handle 66 is pivotably mounted to the two plates 56 therebetween via the pivot pin 64, which is secured to both plates therebetween adjacent the first longitudinal end 68, so as to be retractable. Of course, there is sufficient friction between the handle 66 and the two plates 56 to prevent the undesired retraction of the handle 66 during operation of the device 48.

The retractability of the handle 66 allows providing for a more compact device 48 when it is not in use. According to a further embodiment (not shown), the handle 66 is fixedly mounted to the rope friction controller 52.

The two friction members 58 and 60 and the enlarged portion peripheral the bushing 62 are so relatively positioned and the rope 50 is so cooperatively mounted in the rope friction controller 52 and more specifically cooperatively mounted thereabout as shown in FIG. 8A that the above-mentioned neutral and descent positions can be obtained. Intermediary friction forces are obtained in intermediary angled positions about the pivot axis 72 using the handle 66.

As can be seen in FIG. 8B, the friction finger 54 further acts as a safety element in a panic mode such as described in the afore-mentioned Canadian Patent Application no. 2,639,425, when the user 13 pushes the handle 66 beyond the horizontal position. The friction caused by the tip 74 of the finger 54 on the rope 50 and the angle formed by the entering and departing portions of the rope 50 in and out of the friction controller 52 result in the movement of the rope 50 being blocked by the friction controller 52. The user 13 is thus prevented from falling when he pushes the handle down following a panic attack.

It is to be noted that many modifications could be made to the kit 10 or to the emergency descent control package 20 described hereinabove, such as:
the lanyard 12 can be attached to any structure allowing to securely receive the first attachment portion 16 thereof directly or via a rope, a cable, a chain, a strap or other, which can be provided with a snap hook or with any other attachment;
the lanyard 12 can be omitted or replaced by any other secure link;
even though the attachment portions 16, 18 and other described links are illustrated as being in the form or including a D-ring or a carabineer, each of these attachment portions can take other form or include other attachment or securing means allowing the attachment of the lanyard 12 and more generally the harness 11 to the structure 15 and the control descent device 22 to the harness 11;
other forms of wearable safety equipments can be used instead of the illustrated harness 11 to safely attach the user 13 to the structure 15 via a cable or else and to attach the control descent device 22 to the user. Example of such other wearable safety equipments include, without limitations, rappel belts, escape belts, rescue harnesses, climbing harnesses, and seat harnesses.
the emergency descent control package 20 can be provided with other descending device than the illustrated control descent device 22. For example, the Petzl EXO and Petzl ID's can also be used;
the rescue lanyard 12 can be made independent or integral to the harness 11 or to any other wearable safety equipment. For example, a harness according to a further illustrative embodiment of the present invention (not shown) can be manufactured so as to integrally include a lanyard having the characteristics of the lanyard 10;
the emergency control package 20 can take other form than the illustrated pouch, such as a sac, a bag, etc., carriable or wearable on the back, the belt, or around the arm or the leg of the user.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A kit for emergency descent from a high structure by a user characterized by having a weight, wearing a wearable safety equipment and being attached to the high structure via at least one link attached to the user via the wearable safety equipment; the kit comprising:
a rope-friction controller including a first attaching element for attaching the rope-friction controller to the wearable safety equipment;
a rope cooperatively engaged in the rope-friction controller;
a second attaching element coupled to the rope for securing the rope to the structure via the link;
a pulley coupled to one of the rope, near the second attaching element, and the second attaching element, for creating a hoist with the rope and the first attaching element; the hoist allowing to remove at least some of the weight of the user from the link so as to allow the user detaching himself from the link and to use the rope-friction controller in cooperation with the rope to descent the high structure.

2. A kit as recited in claim 1, further comprising a package for containing the rope-friction controller with the rope and the second attaching element and the pulley.

3. A kit as recited in claim 2, wherein the package is wearable.

4. A kit as recited in claim 1, wherein at least one of the first and second attaching elements is a carabineer.

5. A kit as recited in claim 4, wherein the second attaching element is a carabineer and the pulley is mounted thereto.

6. A kit as recited in claim 1, further comprising a lanyard having a first attachment for securing to the wearable safety equipment and a second attachment for securing to one of the at least one link; the user detaching himself from the link including detaching the first attachment of the lanyard from the wearable safety equipment.

7. A kit as recited in claim 6, wherein the lanyard is shock-absorbent.

8. A method for emergency descent from a high structure by a user characterized by having a weight, wearing a wearable safety equipment and being attached to the high structure via at least one link attached to the user via the wearable safety equipment, the method comprising:
attaching a rope-friction controller having a rope engaged therein to the wearable safety equipment;
attaching the rope to the at least one link;
coupling a pulley to a portion of the rope near the at least one link;
creating a loop with the rope;
creating a hoist with the loop and the pulley;
using the hoist to remove at least some of the weight of the user from the at least one link;
detaching the wearable safety equipment from the at least one link; and
using the rope-friction controller in cooperation with the rope to descent the high structure.

9. A method as recited in claim 8, wherein the user is being attached to at least one link via the wearable safety equipment by a lanyard; wherein detaching the wearable safety equipment from the at least one link includes detaching the lanyard from the wearable safety equipment.
